(19) United States
(12) Patent Application Publication
(10) Pub. No.: US 2003/0014189 A1
(43) Pub. Date: Jan. 16, 2003

(54) System and method for mobile communications terminal positioning

(75) Inventor: Saul R. Dooley, Reigate (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/191,021

(22) Filed: Jul. 8, 2002

(30) Foreign Application Priority Data
Jul. 11, 2001 (GB) 0116903.6

(51) Int. Cl. H04Q 7/20

(52) U.S. Cl. 701/214; 455/456

(57) ABSTRACT

The invention provides for a telecommunications system including means for determining which of a plurality of positioning functions available to a mobile terminal of the system can be used, wherein a transmitting means is provided for transmitting to the mobile communications terminal a signal which serves to indicate one or more of the said plurality of positioning functions as being suitable for use having regard to the location of the said transmitting means.

### FIELD OF INVENTION

The present invention provides for a telecommunications system, and related method, including means for determining which of a plurality of possible positioning functions is suitable for use by a mobile communications terminal of the telecommunications system.

### BACKGROUND TO INVENTION

Such a system and method is known from WO-A-99/46947 which discloses a system and method for providing information to telecommunications network concerning the positioning capabilities of a mobile terminal.

With the growth of mobile communications, and in particular the increasing desire to generate accurate positional information for mobile terminals, a variety of positioning systems have been developed.

At present, a mobile communications terminal such as a mobile telephone is likely to employ positioning technology based on one or more of the following systems.

A GPS system which uses time-of-arrival measurements from a constellation of satellites. This system is best limited to outdoor environments since GPS signals are not generally detectable indoors. However, when signals can be received, the system can achieve a positioning accuracy to within a few meters.

So-called Cellular Positioning employs time-of-arrival measurements from mobile phone basestations, e.g. using E-OTD or AFLT systems and an accuracy to within 50 m can be achieved for urban cells.

In a Cell-ID system, the co-ordinates of a signal serving basestation are used as an estimate of the position of the handset. Accuracy is dependent upon the size of the cell, which is typically 1 km for urban cells.

In a Bluetooth local positioning system, Bluetooth transmitters communicate their locations to the handset over a short range Bluetooth radio link and the handset is provided with a processing capability for averaging received positions in order to position itself. While this system requires an infrastructure of Bluetooth transmitters, it can advantageously offer an accuracy to within 10-20 m.

Finally, ultra-wideband (UWB) positioning employs time-of-arrival measurements from UWB “localizers”. This positioning requires an infrastructure of UWB localizers but an accuracy to within a few cm can be achieved.

As recognized in WO-A-99/46947, it is generally thought advantageous to provide a mobile communications terminal with functionality for two or more such positioning systems. When such a plurality of positioning functions is available in a mobile terminal, a choice then arises between which function should be used by the mobile terminal in order to derive the positional information.

While WO-A-99/46947 recognizes that one or more of the available positioning functions might prove more appropriate than any one or more of the others, the system and method proposed in this document is considered unnecessarily complex and can also exhibit undesired power-requirement overheads and exhibit general inefficiencies. Also, such a known system and method disadvantageously requires input from a mobile terminal itself when seeking to identify the optimum positioning function that should be employed.

### OBJECT OF INVENTION

The present invention seeks to provide for a system and method for mobile communications terminal positioning which offers an advantage over known such systems and methods.

### SUMMARY OF INVENTION

According to one aspect of the present invention there is provided a system of the above-mentioned type, characterized by a transmitting means arranged for transmitting to a mobile communications device a signal which serves to indicate one or more of the said plurality of positioning functions as being available for use having regard to the location of the said transmitting means.

Such a system is particularly advantageous in that it need not require prior knowledge of the positioning capabilities of the mobile terminal and can simply be arranged to transmit a signal offering information identifying the one or more positioning functions that should be considered for use. This can lead to an efficient means for determining the optimum function without creating a disadvantageous power overhead at the mobile terminal.

According to another aspect of the present invention; there is provided a method of determining which of a plurality of positioning functions available to a mobile communications system can be used and characterized by the steps of transmitting to the mobile communications terminal a signal which is arranged to indicate one or more of the said plurality of positioning functions as being suitable for use, the said identification being provided on the basis of the location of the source of the said transmitted signal.

The features of claim 2 and 3 prove advantageous in preventing attempted use by the terminal of positioning systems that, given the particular location, will not give a suitably useable or accurate position fix.

claim 4 is advantageous in allowing for a determination of accuracy of the one or more possible positioning systems either on an absolute basis and/or a relative basis.

The subject matter of claim 5 advantageously allows for automatic selection of the one or more positioning system in the terminal.

The features of claim 6 and 7 allow for the transmission of signals determined by accurate and specific details relating to the immediate locality.

Further, a network of stationary beacons can act as an aid to terminal positioning by wirelessly broadcasting or supplying on request information relevant to a user should he/she require that a position-fix be carried out. For example, a user who is familiar with GPS could enter a building where a beacon on the door provides a signal indicating that GPS will not be available while in that building and that, for example, a Bluetooth Local Positioning function should be employed. Alternatively a beacon in the street can be arranged to provide a signal indicating that cellular positioning should not be used because the user is in a location known to exhibit severe multipath problems. As noted, this potentially saves a user's time and terminal battery consumption by preventing the device from attempting a position fix using a technology which will render no, or at best an inaccurate, result.

Advantageously, specific assistance parameters peculiar to each positioning technology could be appended to the broadcast. In particular, the local beacons can offer a signal having characteristics determined by immediate surroundings and so identify which positioning system is best suited to such surroundings.

According to yet another aspect of the present invention, there is provided a transmitter arranged for transmitting a signal to a mobile communications terminal arranged to operate with a plurality of positioning functions, and arranged such that the signal serves to indicate one or more of the plurality of positioning functions as being suitable for use having regard to he location of the transmitter.

According to yet a further aspect of the present invention, there is provided a mobile communications terminal arranged to employ a plurality of positioning functions, and characterized by receiving means arranged to receive a signal indicating one or more of the said plurality of positioning functions as being suitable for use by the terminal having regard to the location of the source of the said signal.

In some instances, it should be appreciated that, multiple technologies may meet the same accuracy requirement of any particular application. For example, if an application requires accuracy to within 50 m, the terminal may employ GPS, Cellular, UWB or Bluetooth functions generally at the users discretion.

Given the need for an integral power supply for a mobile terminal, if is advantageous to indicate that the user does not, for example, want his/her handset searching for GPS satellites and so wasting time and power when he/she is in a location where there are no GPS signals, but where other positioning functions are available such as, for example, a UWB network.

### DESCRIPTION OF DRAWINGS

The invention is described further hereinafter, by way of the example only, with reference to, and as illustrated in, the accompanying drawings in which:

FIG. 1 is a schematic representation of a mobile communications terminal forming part of an associated telecommunications system according to an embodiment of the invention; and

FIG. 2 is a schematic representation of a transmitter arrangement for use in the system of FIG. 1.

### DETAILED DESCRIPTION

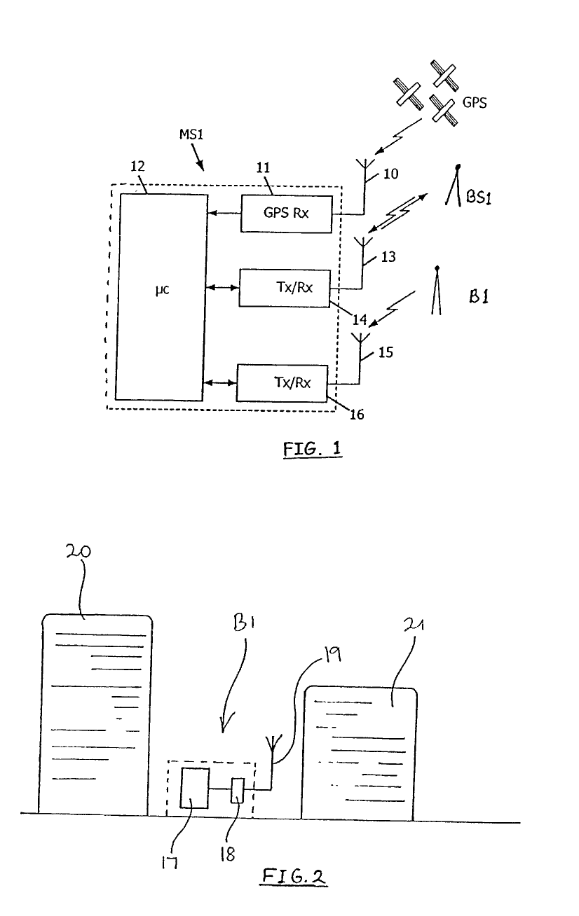

Turning now to FIG. 1, there is illustrated a mobile communications terminal MS1 including an antenna means 10 arranged to receive a GPS signal from a constellation of GPS satellites, which signal is delivered to a GPS receiver 11 for onward delivery as appropriate to a micro-processor 12 within the mobile communications device MS1 which, in the illustrated example, can comprise a mobile telephone.

A further antenna arrangement 13 is also provided with the mobile terminal MS1 and so as to allow for two-way communication with a basestation BS1 so as to allow for, for example, standard cell phone functionality which will not be described in detail here. The antenna 13 connects to the micro-processor 12 by means of a communications transmitter/receiver 14.

Also included in the mobile terminal MS1 is yet another antenna arrangement 15 is arranged only to receive a signal from a beacon B1 for onward delivery to a positioning control/receiver 16 which, as with the receiver 11 and transmitter receiver 14, delivers signals as appropriate to the micro-processor 12.

As will be appreciated, the mobile terminal MS1 has a functionality to allow for the receipt of signals from the constellation of satellites GPS to allow for, in an appropriate environment, positioning accuracy to within a few meters. The communications connection afforded by way of the transmission/reception between the antenna 13 and the basestation can also be employed to provide for positioning schemes such as cellular position and cell-ID positioning as are commonly separately known in the art.

Thus, with a mobile terminal MS1 such as that illustrated in the drawing, the user is provided with a choice of positioning methods that can be deployed in order to locate the position of the mobile terminal.

In accordance with the present invention, the mobile terminal MS1 is further arranged with a positioning control antenna 15 and associated receiver 16 which is arranged to receive a signal transmitted from a beacon B1.

In accordance with a particular embodiment of the present invention, the illustrated beacon B1 comprises one of a network of beacons arranged to transmit local signals for receipt by mobile terminals such as MS1 when in the vicinity of the each beacon.

The beacon B1 is arranged to transmit a signal serving to identify which of the possible positioning methods is the most appropriate either directly or, by default by indicating which one or indeed which one or more of the positioning methods cannot in fact be used within the locality in which the beacon B1, and thus the mobile terminal MS1, is found.

Advantageously, the beacon B1 need not know what particular positioning capability the mobile terminal MS1 has since it can achieve its required functionality merely by identifying which positioning system would not, for example, be appropriate for use in, or around, that particular location. Of course; if the particular mobile terminal concerned does not in any case have such potential functionality then the desire to prevent the choice of that position method being selected would not in any case arise. Also, in the absence of a suitable controlling-signal, the mobile terminal can switch to a default functionality.

An example of the proposed solution is for a handset to receive data from the service provider about what positioning technology it recommends (and those it strongly does not recommend) at a certain location. These recommendations may be based on infrastructure provision such as if a UWB positioning system has been installed, or empirical measurements such as the recommendation to not attempt to use GPS in a particular environment due to empirical measurements or prior knowledge that GPS signal reception is inhibited there.

The users handset does not then waste time and power testing each of the possible positioning functions available to it as it has been advised of the likely optimum function to employ.

In the illustrated example, beacon B1 is arranged to send recommendations for what positioning system to use, without knowledge of what is in the handset. This simplifies the manner in which the advantages can be achieved as it requires merely one-way communication such as broadcasting over B1uetooth if desired. Also, the arrangement can serve to inform users about proprietary systems, such as Local Positioning, and therefore the software in the handset can select which positioning system to use. Because, for example, B1uetooth beacons offer a short range signal, this signal can readily be employed to impart accurate information concerning aspects of the surrounding environment, such as whether GPS can be received or whether multipath problems might arise. A user whose default positioning is GPS, does not then spend several minutes of valuable battery power trying to acquire GPS when there is no GPS coverage.

With reference now to FIG. 2, there is illustrated a schematic representation of the transmitter B1 of FIG. 1. As mentioned, the transmitter B1 serves to provide a signal which can be employed by a mobile communications terminal to determine which one or more of a plurality of positioning function capabilities at the terminal should be employed. The transmitter B1 includes a processor 17 and transmitter controlled 18 which serve to deliver the signal to an antenna 19. The processor 17 can be controlled to impart information into the signal transmitted from the antenna 19 which serves to indicate one or more suitable positioning functions selected on the basis of local environmental factors. For example, in FIG. 2, the transmitter B1 is associated with an area of relatively high density tall buildings 20, 21 which might prevent receipt of GPS signals and possibly present multipath problems. The signal can then indicate which one or more of the positioning functions is suitable having regard to such factors. The processor can be re-programmed as required to take account of changes in the local environment etc.

Further, a beacon system could be employed whose function is to register users locations in a logical context such as in a building, airport, in the street etc. The system is then arranged to instruct the user to use a certain positioning system, and further serves to de-register the user when departing that locality. During the time when the user is in the particular locality, the handset can automatically select the optimal positioning technology by following what is recommended by the beacon system operator. For example, if a user enters a building, a beacon on the door may tell the user that UWB positioning should be used in this building. As long as the handset determines that it is in the building, need not then seek to use any other technology.

As a further feature, specific assistance data such as GPS assistance data could be appended to the broadcast.

It should therefore be appreciated that a principal example of the present invention allows for the supply, from an information beacon over a short range wireless link to a mobile communications terminal, of information relating to positioning functions which can be used in the locality of the information beacon to obtain a position fix. Such information may include any one or more of which positioning systems are operative in he vicinity, for example, GPS, cellular, Bluetooth local positioning or any particular proprietary system; an estimate of the degree of accuracy of a position fix that can be obtained with any of the possible operative positioning systems; and which positioning systems are preferred, for example, a beacon may recommend to a user not to use cellular positioning because of severe multipath.

The invention is not restricted to the detail of the foregoing embodiment for example, the system can employ any appropriate form of mobile terminal and can be arranged to deliver a signal to that terminal providing the positioning function information through any appropriate medium.

1. A telecommunications system including means for determining which of a plurality of positioning functions available to a mobile terminal of the system can be used, characterized by transmitting means for transmitting to the mobile communications terminal a signal which serves to indicate one or more of the said plurality of positioning functions as being suitable for use having regard to the location of the said transmitting means.

2. A system as claimed in claim 1, wherein the signal is arranged to identify at least one of the positioning functions as appropriate or available.

3. A system as claimed in claim 1, wherein the said signal is arranged to identify at least one positioning functions as inappropriate or unavailable.

4. A system as claimed in claim 1, wherein the signal is arranged to provide an indication to the mobile terminal of the likely accuracy of one or more of the positioning functions.

5. A system as claimed in claim 1, wherein the said signal is arranged to control selection within the mobile terminal of the positioning function employed to obtain a position fix.

6. A system as claimed in claim 1, and including a plurality of stationary transmitting means.

7. A system as claimed in claim 6, wherein the plurality of transmitting means comprises a network of beacons.

8. A method of determining which of a plurality of positioning functions available to a mobile terminal of a communications system can be used, characterized by the step of transmitting to the mobile communications terminal a signal which is arranged to indicate one or more of the said plurality of positioning functions as being suitable for use, the indication being provided on the basis of the location of the source of the said transmitted signal.

9. A method as claimed in claim 8, for use with a system as claimed in claim 2.

10. A transmitter arrangement for transmitting a signal to a mobile communications terminal arranged to operate with a plurality of positioning functions, and arranged such that the signal serves to indicate one or more of the plurality of positioning functions as being suitable for use having regard to the location of the transmitter.

11. A transmitter arrangement as claimed in claim 10, and arranged for operation within a communications system as claimed in claim 2.

12. A mobile communications terminal arranged to employ a plurality of positioning functions, and characterized by receiving means arranged to receive a signal indicating one or more of the said plurality of positioning function as being suitable for use by the terminal having regard to the location of the source of the signal.

13. A mobile communications terminal as claimed in claim 12, and arranged to operate within a communications system as claimed in claim 2.
